(19) United States
(12) Patent Application Publication
(10) Pub. No.: US 2006/0026315 A1
(43) Pub. Date: Feb. 2, 2006

(54) Apparatus and method of establishing data transmission speed for serial advanced technology attachment interface

(76) Inventors: Si-Hoon Hong, Yongin-si (KR); Sang-Kyoo Jeong, Seoul (KR)

Correspondence Address: HARNESS, DICKEY & PIERCE, P.L.C., P.O. BOX 8910, RESTON, VA, 20195, US

(21) Appl. No.: 11/189,881

(22) Filed: Jul. 27, 2005

(30) Foreign Application Priority Data
Jul. 29, 2004 (KR) 2004-59815

(51) Int. Cl. G06F 13/38

(52) U.S. Cl. 710/60

(57) ABSTRACT

An apparatus and method of establishing data transmission speed between a host and a device connected to a serial Advanced Technology Attachment (ATA) interface, the method includes initiating a first data transmission speed between the host and the device, transmitting a data transmission speed change command, and initiating a second data transmission speed different from the first data transmission speed in response to the data transmission speed change command.

### CLAIM FOR PRIORITY

A claim of priority is made to Korean Patent Application No. 2004-59815 filed on Jul. 29, 2004, in the Korean Intellectual Property Office (KIPO), the entire contents of which are hereby incorporated by reference.

### BACKGROUND OF THE INVENTION

1. Field of the Invention

The present invention generally relates to a method of establishing data transmission speed of a Serial Advanced Technology Attachment (SATA) interface. More particularly, the present invention relates to a method of establishing data transmission speed of the SATA interface capable of minimizing power consumption.

2. Description of the Related Art

Advanced Technology Attachment (ATA) interface is a computer industry standard. The ATA interface standard is used to establish and transfer data and information from a host system to a storage device. The ATA interface standard permits compatibility between the host system and the storage device, even if the host system and the storage device were manufactured by different manufactures.

Serial Advanced Technology Attachment (SATA) is related to Parallel ATA (PATA), except cables used to connect the host system and storage devices are in serial and data are transmitted one bit at a time. The SATA has better ventilation then the PATA, because the SATA utilizes a simpler internal wire connection scheme, such as reduced number of connector data pins. In addition, due to the reduced number of signals, the SATA consumes less power. The SATA is also backward compatible; therefore, an Operating System does not require a new driver for each device or host.

In general, the SATA supports three transmission speeds, i.e., 1.5 Gbps, 3 Gbps, and 6 Gbps, which relates to 1^{st} to 3^{rd} generations, respectively. Therefore, a system capable of operating at the highest speed must also be able to support at a lower speed in order to be backwards compatible. In other words, one device may be a first generation device operating at 1.5 Gbps, while another device may be a third generation device operating at 6 Gbps, but both speeds must be reported.

In the case of a mobile product operating with a portable battery, in the current trend it is essential to reduce power consumption. It is also essential to upgrade data transmission speed to increase system performance. However, unnecessarily high data transmission speed creates a negative effect on power consumption. Therefore, there is a demand for systems capable of adapting more efficient data transmission speeds with reduce power consumption.

FIG. 1 is a flowchart illustrating a conventional method of determining data transmission speed between a host and a device connected by a SATA interface.

A method of determining data transmission speed for the SATA interface is disclosed in Serial ATA, Rev. 1.0, published on Aug. 21, 2001.

Referring to FIG. 1, power is supplied to a system in step S110. The highest data transmission speed is selected using the following equation: 1.5×2ⁿ⁻¹ Gbps (n: natural number), in step S120. The selected data transmission speed is tested in step S130. Then, it is determined whether the data transmission at the selected data transmission speed is supported in step S140. In the case the data transmission is not supported at the selected data transmission speed, a lower data transmission speed is selected in step S150. In the case the data transmission is supported at the selected data transmission speed, the selected data transmission speed is maintained in step S160.

In further detail, power is applied to the host and the device at the same time so that data transmission between the host and the device is possible in step S110.

In step S120, because a SATA interface is capable of supporting three different data transmission speeds, e.g., 1.5 Gbps, 3 Gbps, 60 bps, the interface transmission speed is selected to 6(n=3) Gbps, which is the highest data transmission speed supported by the host.

In step S130, a test is performed and the result of the test is reported.

In step S140, it is determined whether the data transmission at the selected data transmission speed is supported based on the test result from step S130. In the case the data transmission is supported at the selected data transmission speed, then the selected data transmission speed is maintained in step S160. However, if the data transmission is not supported at the selected data transmission speed, steps S120 through S140 are repeated at the next highest data transmission speed in step S150. For example, if a test is performed at 6 Gbps data transmission speed, and the data transmission is not supported, then the test is repeated at 3 Gbps data transmission speed, which is the next available data transmission speed.

In summary, the data transmission speed of the interface between the host and the device in a system is determined by the following steps: A designated signal varies from the highest data transmission speed to the lowest data transmission speed among the host supportable data transmission speeds, and the designated signal is sequentially supplied to the device. The device generates a reply signal in response to the designated signal, and determines the data transmission speed of the designated signal that is initially detected by the device.

FIG. 2A is a flowchart illustrating step S130 of FIG. 1 performed by a host. FIG. 2B is a flowchart illustrating step S130 of FIG. 1 performed by a device.

FIG. 3A is a sequence diagram illustrating a signal protocol for data transmission of a SATA interface controlled by a host. FIG. 3B is a sequence diagram illustrating a signal protocol for data transmission of a SATA interface controlled by a device.

Referring to FIG. 2A-FIG. 3B, a description of a conventional method of determining the data transmission speed will be described.

Referring to FIG. 2A and FIG. 3A, in the case the host controls the steps of determining data transmission and data transmission speed between the host and the device, the host performs the following steps. A COMRESET signal is generated and transmitted by the host in step S131. A COMINIT signal is received in step S132. A COMWAKE signal is generated and transmitted by the host in step S133. An ALIGN signal is transmitted at a selected data transmission speed in step S134.

In detail, when the host and the device are power-on, in step S131, the host generates a first matching signal, i.e., a COMRESET signal, and transmits the COMRESET signal to the device.

When the device detects the COMRESET signal transmitted by the host, in step S132, and then the device generates a second matching signal, i.e., a COMINIT signal, in response to the COMRESET signal. In a protocol, the COMRESET and the COMNINIT signals have identical periods and a fixed pattern, thereby providing compatibility.

In step S133, the host generates a third matching signal, i.e., COMWAKE signal in response to the COMNINIT signal, and transmits the COMWAKE signal to the device. In response, the device also generates a fourth matching signal, i.e., a COMWAKE signal, and transmits the COMWAKE signal to the host. In the protocol, the COMWAKE signal has an identical period and a fixed pattern, thereby providing compatibility. The first through the fourth matching signals are defined as Out of Band (OOB) signal in the protocol, and format and response method of the first through the fourth matching signals are defined as a given pattern.

In step S134, 2048 double words of ALIGN burst signal at the selected data transmission speed of the SATA interface are generated by both the host and the device, and the 2048 double words of ALIGN burst signals are transmitted to each other at the selected data transmission speed. Because the ALIGN burst signal is similar to actual data, it can be determined whether the selected data transmission speed (S120) between the host and the device is supported.

Referring to FIG. 2B and FIG. 3B, in the case steps for determining data transmission speed between the host and the device are controlled by a device, the device performs the following steps: The COMINIT signal is generated and transmitted by the device in step S135. A COMWAKE signal is generated and transmitted by the device in step S136. An ALIGN signal is transmitted and received at the selected data transmission speed by the device in step S137. It is noted that FIG. 2B illustrates the flow of signals in the device. In addition, the n-th matching signal is related with sequence of signals predefined in protocol, but not a specific signal.

In detail, when a host and a device are power-on, the device generates a first matching signal, i.e., COMINIT signal, and transmits the COMINIT signal to the host in step S135.

In step S136, in the case the host detects the COMINIT signal sent by the device, the host generates a second matching signal, i.e., COMWAKE signal, in response to the COMINIT signal and transmits the COMWAKE signal to the device. The device also generates a third matching signal, i.e., COMWAKE signal, in response to the COMWAKE signal received from host, the device transmits the COMWAKE signal to the host. Because the COMWAKE signals, which are generated by both the host and the device, and in the protocol, the COMWAKE signals have identical periods and a fixed pattern, thereby providing compatibility.

In step S137, the device generates a fourth matching signal, i.e., 2048 double words of an ALIGN burst signal, at the selected data transmission speed of the SATA interface, and transmits the ALIGN burst signal to the host. The host generates a fifth matching signal having the same pattern as that of the fourth matching signal in response to the fourth matching signal and transmits the fifth matching signal to the device again. Because the ALIGN burst signal is similar to actual data, it can be determined whether the selected data transmission speed (S120) between the host and the device is supported. In the conventional method, for example, in the case the device supporting 6 Gbps of data transmission speed is connected with the host, the data transmission speed of the interface between the host and the device is determined only to 6 Gbps because the host outputs a reply signal in response to the maximum data transmission speed. Therefore, the data transmission speed in the conventional methods cannot be controlled during the speed test, therefore, reduction in power consumption cannot be accomplished.

### SUMMARY OF THE INVENTION

In an embodiment of the present invention, a method of establishing data transmission speed between a host and a device connected to a serial Advanced Technology Attachment (ATA) interface, includes initiating a first data transmission speed between the host and the device, transmitting a data transmission speed change command, and initiating a second data transmission speed different from the first data transmission speed in response to the data transmission speed change command.

In another embodiment of the present invention, a method of establishing data transmission speed between a host and a device connected to a serial Advanced Technology Attachment (ATA) interface, includes initiating a first data transmission speed between the host and the device, transmitting a data transmission speed change command, initiating a second data transmission speed different from the first data transmission speed in response to the data transmission speed change command, determining whether data transmission at the second data transmission speed is supported, and maintaining the second data transmission speed if the second data transmission is supported.

In still another embodiment of the present invention, a method of establishing data transmission speed between a host and a device connected to a serial Advanced Technology Attachment (ATA) interface includes initiating a first data transmission speed between the host and the device, transmitting a data transmission speed change command, initiating a second data transmission speed different from the first data transmission speed in response to the data transmission speed change command, determining whether data transmission at the second data transmission speed is supported, outputting an error result when the data transmission at the second data transmission speed is not supported, and determining whether a different data transmission speed other than the second data transmission speed is supported.

### BRIEF DESCRIPTION OF THE DRAWINGS

The above and other aspects of the present invention will become more apparent with the detail description of example embodiments thereof with reference to the accompanying drawings, in which:

FIG. 1 is a flowchart illustrating a conventional method of determining data transmission speed of a SATA interface;

FIG. 2A is a flowchart illustrating in detail step S130 of FIG. 1;

FIG. 2B is a flowchart illustrating in detail step S130 of FIG. 1;

FIG. 3A is a sequence diagram illustrating a signal protocol for data transmission of the SATA interface controlled by a host;

FIG. 3B is a sequence diagram illustrating a signal protocol for data transmission of the SATA interface controlled by a device;

FIG. 4 is a flowchart showing a method of establishing data transmission speed of the SATA interface according to an example embodiment of the present invention;

FIG. 5 is a flowchart illustrating a re-selection of the data transmission speed in the method of establishing data transmission speed of FIG. 4;

FIG. 6 is a flowchart illustrating a test to determine data transmission support performed by a device; and

FIG. 7 is a block diagram illustrating an apparatus for controlling data transmission speed of SATA interface according to an example embodiment of the present invention.

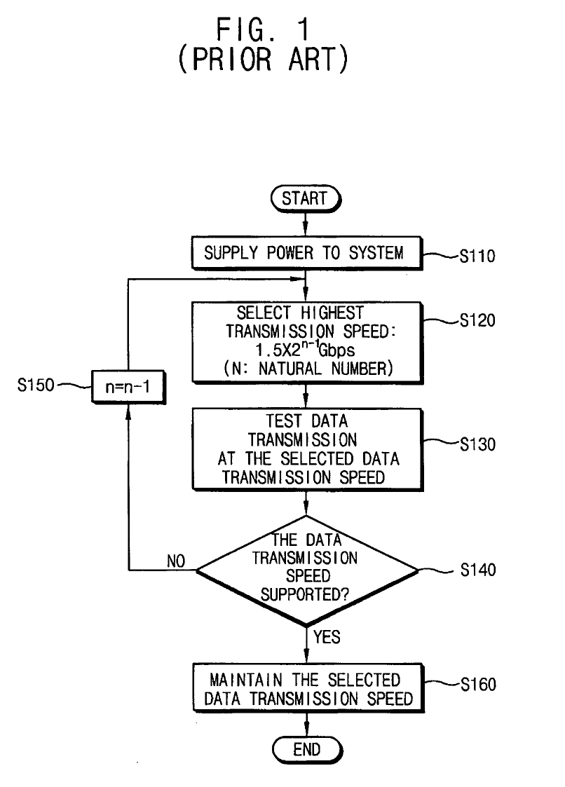

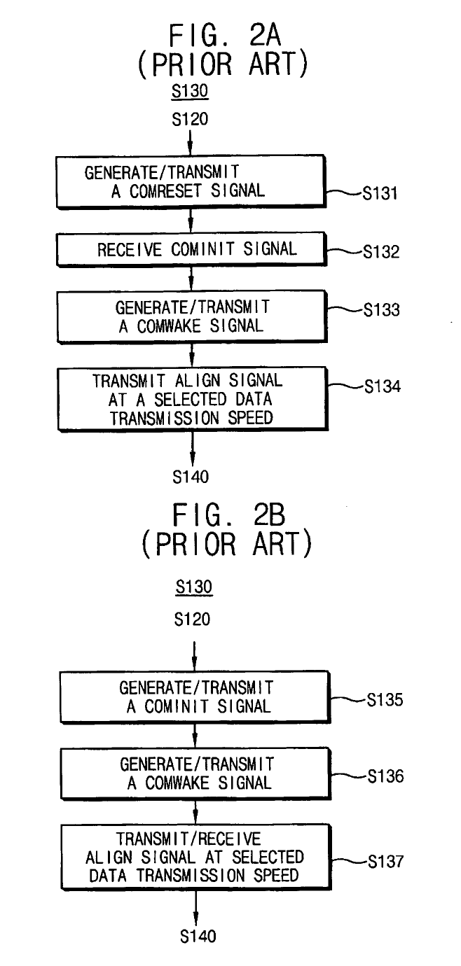

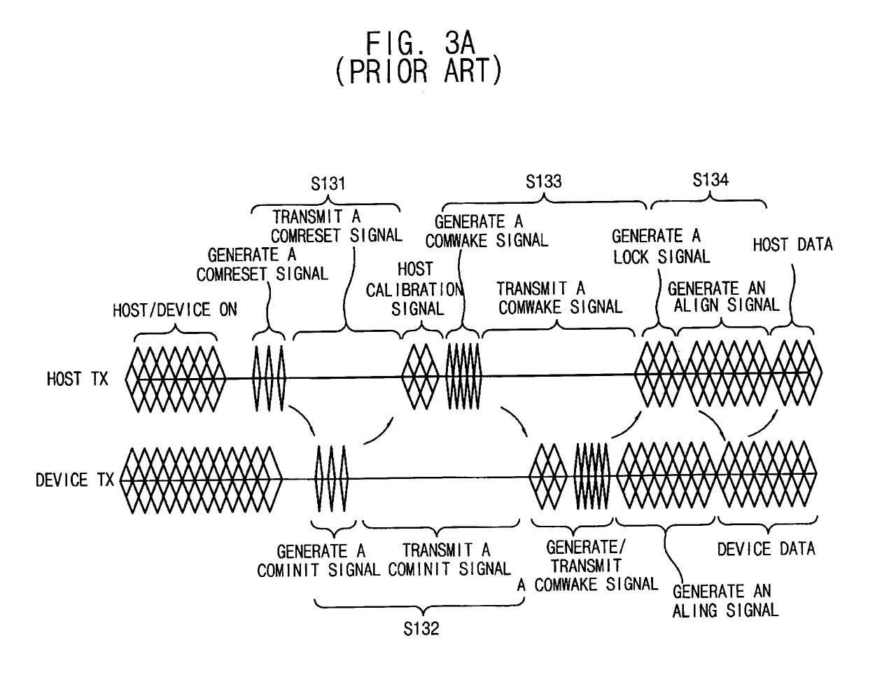

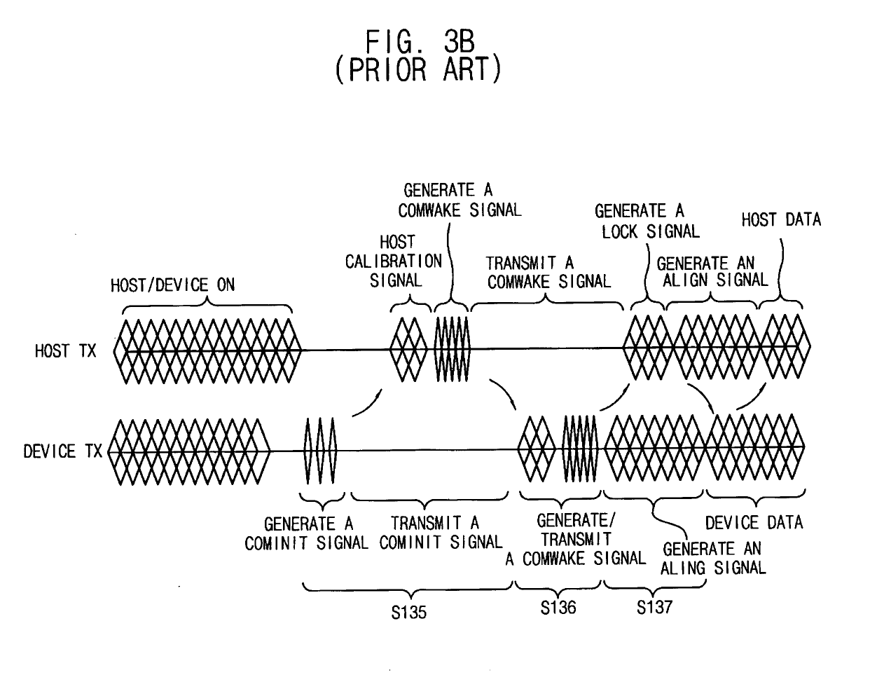

### DESCRIPTION OF EMBODIMENTS

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to the embodiments set forth herein.

Accordingly, while the invention is capable of various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the scope of the invention. Like numbers refer to like elements throughout the description of the figures.

It should also be noted that in some alternative implementations, the functions/acts noted in the blocks might occur out of the order noted in the flowcharts. For example, two blocks shown in succession may in fact be executed substantially concurrently or the blocks may sometimes be executed in the reverse order, depending upon the functionality/acts involved.

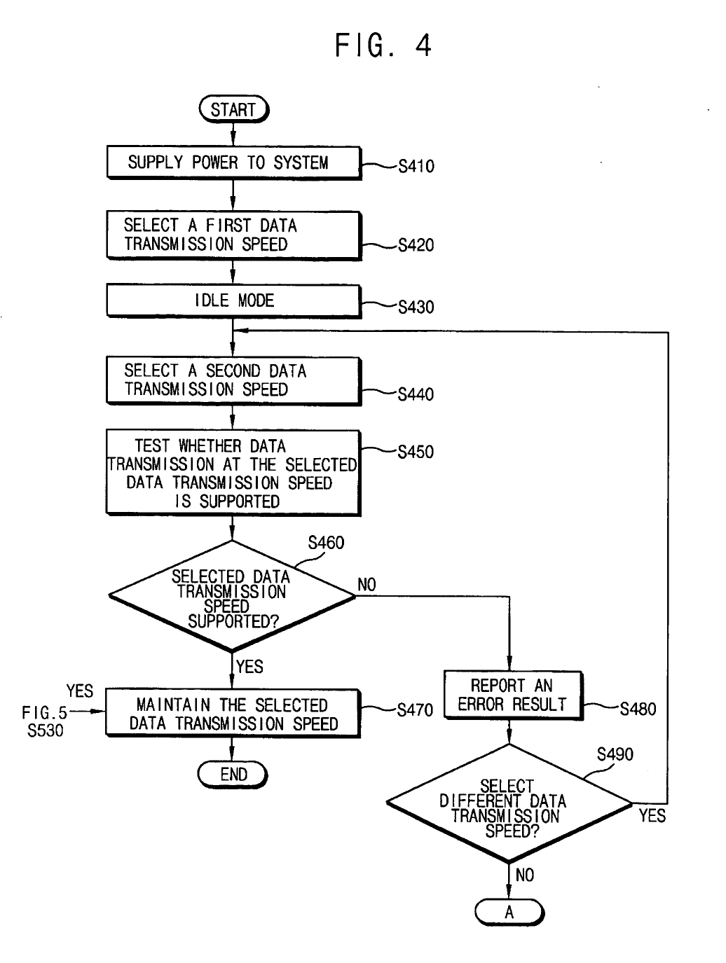

FIG. 4 is a flowchart illustrating a method of establishing data transmission speed of a SATA interface according to an example embodiment of the present invention.

Referring to FIG. 4, power is supplied to a system in step S410. Data between a host and a device are transmitted at a first data transmission speed in step S420. An idle mode is performed in step S430. A second data transmission speed is selected in step S440. The second data transmission speed is tested in step S450. In step S460, it is determined whether the data transmission is supported at the second data transmission speed between the host and the device connected to the SATA interface. The second data transmission speed is maintained if the data transmission is supported at the second data transmission speed in step S470. However, an error is reported if the data transmission is not supported at the second data transmission speed in step S480. A different data transmission speed is selected when the data transmission is not supported at the second data transmission speed in step S490.

In detail, when power is supplied to the system, in step S410 and step S420, the system initializes to have the first data transmission speed. As the power is supplied to the system, the data transmission speed is automatically determined by a default value at an initial condition. In an example embodiment, the first data transmission speed may be determined by hardware, for example, by a switch.

In step S430, the system operates at the first data transmission speed in step S420, and data transmission is performed between the host and the device.

In step S440, for the purpose of reducing power consumption, a user arbitrarily selects the second data transmission speed. As disclosed above, fast data transmission speed for the system or a fast function leads to deteriorated power characteristics; step S440 is performed to adequately establish the data transmission speed. The second data transmission speed may be selected based on a data transmission command, i.e., a data transmission speed change command.

The second data transmission speed is tested in step S450.

In step S460, it is determined whether data transmission is supported based on the test results from step S450. In the case data transmission is supported at the second data transmission speed, step S470 is performed and data transmission between the host and the device occurs. If the data transmission is not supported at the second data transmission speed, then step S480 is performed.

In the case the second data transmission speed is not supported, an error result is reported in step S480.

In step S490, it is determined whether a different data transmission speed can be selected.

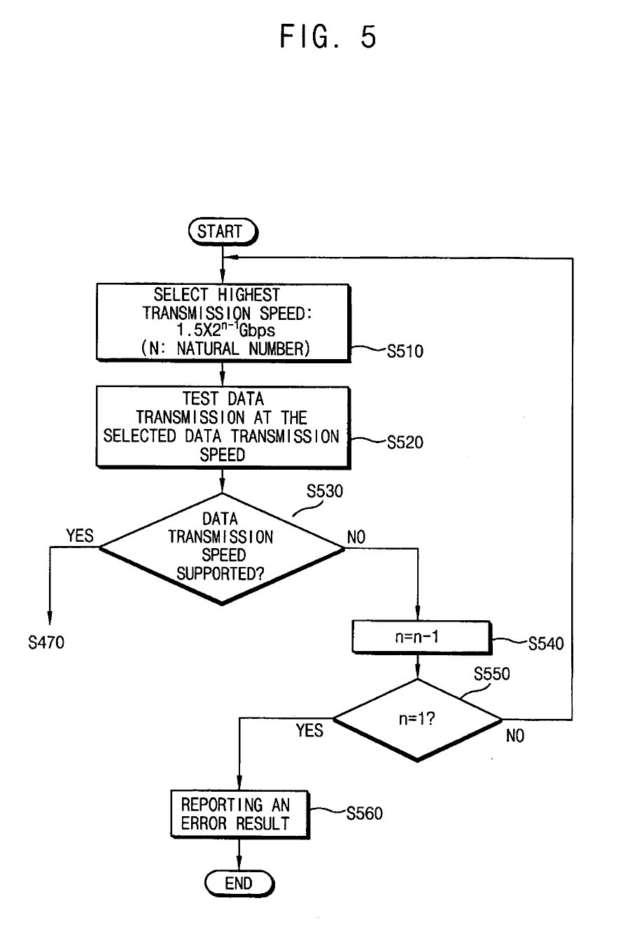

FIG. 5 is a flowchart illustrating selection of a different data transmission speed.

Referring to FIG. 5, the establishing method of a SATA data transmission speed according to the example embodiment of the present invention includes: selecting a highest data transmission speed using: 1.5×2ⁿ⁻¹ Gbps (n: natural number) in step S510, testing the selected data transmission speed in step S520, determining whether data transmission is supported in step S530, selecting a different data transmission speed slower than the selected data transmission speed in step S540, step S550, and reporting an error result in step S560.

In step S510, the highest data transmission speed that can be supported by the SATA interface is selected among the available data transmission speeds. For example, in the case the SATA interface supports 1.5 Gbps, 3 Gbps and 6 Gbps for data transmission, 6(n=3) Gbps is selected as the maximum data transmission speed.

In step S520, the selected data transmission is tested.

In step S530, it is determined whether the data transmission between the host and the device is possible at the selected highest data transmission speed based on the test results from step S520. In the case data transmission is supported at the the selected maximum data transmission, the process moves to step S470 in FIG. 4, and the selected maximum data transmission speed is maintained.

In step S540, in the case the device cannot operate at the selected highest data transmission speed based on result from step S520, the next available data transmission speed is selected, excluding the previously selected data transmission speed. For example, in step S540, if the first selected data transmission speed was 6 Gbps, a data transmission speed of 3 Gbs is selected as the next available data transmission speed.

In step S550, it is determined whether the tested data transmission speed is the slowest data transmission speed. In the case the tested data transmission speed was not the slowest data transmission speed, step S510 is repeated with the newly selected data transmission speed. However, if the tested data transmission was the slowest data transmission speed, a signal reporting an error is outputted in step S560.

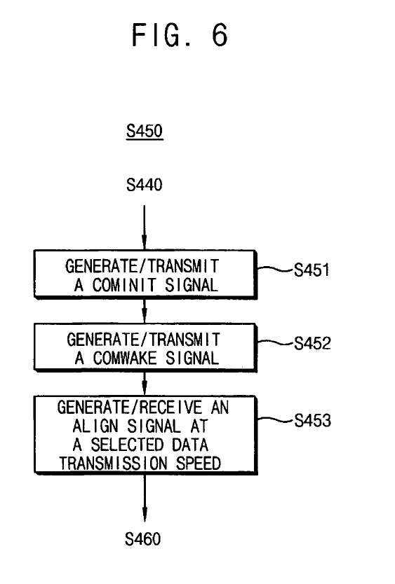

FIG. 6 is a flowchart illustrating in detail step S450 of FIG. 4.

Step S450 includes the following steps. A COMINIT signal is generated and transmitted in step S451. A COMWAKE signal is generated and transmitted in step S452. In addition, an ALIGN burst signal is transmitted and received in step S453 at the selected data transmission speed. In this case, it is noted that the n-th matching signal is related with a sequence of signals, which are exchanged between the host and the device and are predefined in the protocol, but not a specific signal.

In step S451, the device generates a first matching signal, i.e., COMINIT, and transmits the COMINIT signal to the host.

In step S452, the host generates a second matching signal, i.e., COMWAKE, and transmits the COMWAKE signal to the device in response to the COMINIT signal. The device generates a third matching signal, i.e., COMWAKE, and transmits the third matching signal COMWAKE to the host in response to the second matching signal COMWAKE. In addition, the device generates a fourth matching signal, i.e., ALIGN burst signal, and transmit the ALIGN burst signal to the host. The ALIGN burst signal has a similar pattern to an actual transmitted data pattern. In addition, it may be determined whether the interface between the host and the device is possible at the second data transmission speed identical to the transmission speed of the actual transmitted data.

In step S453, the host generates a fifth matching signal, i.e., ALIGN burst signal, in response to the third matching signal COMWAKE, and the fifth matching signal ALIGN burst of the host is transmitted to the device, and the device outputs its data. In response, the host sends its data to the device.

Thus, an interface speed between a host and a device is not determined arbitrarily at the highest available interface speed. Rather, the interface speed is determined based on a data transmission speed change command, which may be provided by a user.

Both the host and the device may determine the data transmission speed.

According to an example embodiment of the present invention, conventional protocol that determines the data transmission speed of the interface between the host and the device may be used; therefore, an embodiment of the present invention is compatible with other conventional devices.

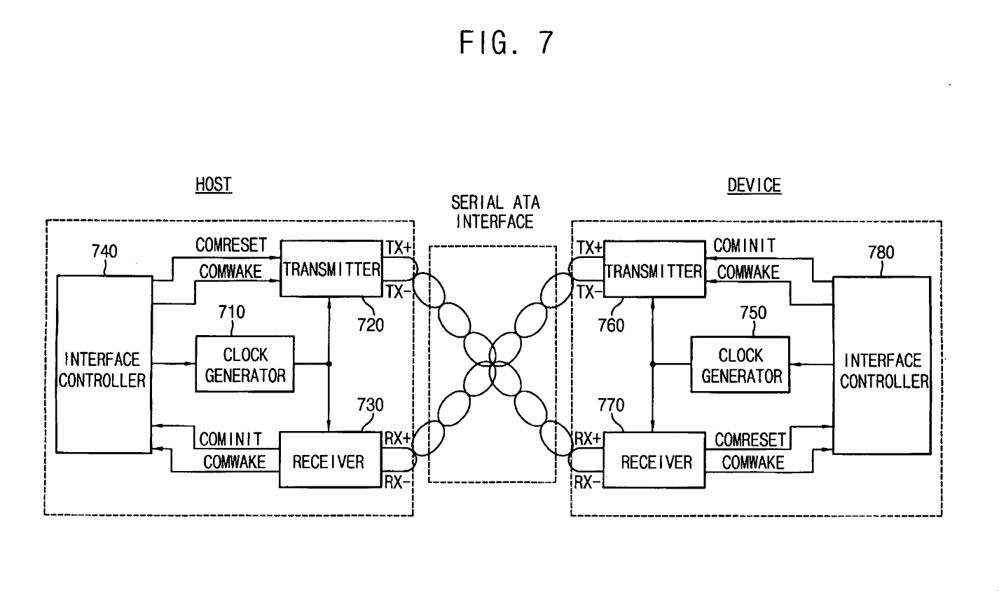

FIG. 7 is a block diagram illustrating an apparatus for controlling data transmission speed of a SATA interface according to an example embodiment of the present invention.

Referring to FIG. 7, the apparatus for controlling data transmission speed of the SATA interface according to an example embodiment of the present invention includes clock generators 710, 750, transmitters 720, 760, receivers 730, 770, and interface controllers 740, 780 in a host and a device, respectively.

The clock generator 710, 750 generates a clock signal based on the available data transmission speed.

The transmitters 720, 760 transmit data through a transmission line in response to the clock signal generated by the clock generators 710, 750, respectively.

The receivers 730, 770 receive data through the transmission line in response to the clock signal generated by each of the clock generators 710 and 750.

The interface controllers 740, 780 generate a specific pattern and matching signals to select the appropriate data transmission speed. The interface controllers 740, 780 receive each of incoming matching signals (COMRESET, COMINIT, COMWAKE) from each of the receivers 730, 770, and generate matching signals that correspond to the incoming matching signals and are predefined in the protocol, and transmit the generated matching signals through the transmitters 720, 760.

In addition, each of the interface controllers 740, 780 may have a mode register for selecting a plurality of data transmission speed modes. For example, binary sets 00, 01, 10, 11 can be pre-assigned to data transmission speed modes 1.5 Gbps, 3 Gbps, 6 Gbps, and undefined, respectively. In this case, when a data transmission speed change command is received, data stored in the mode register is read out in response to the received data transmission speed change command. Therefore, the data transmission speed between the host and the device can be controlled at an arbitrary data transmission speed among the plurality of data transmission speed according to a user's preference.

According to another example embodiment of the present invention, a method of selecting data transmission speed may be implemented by supplying an external control signal directly through a control signal input pin(s). Particularly, each of the host and the device may include a control signal input pin(s) for selecting one of the plurality of data transmission speeds, and thus it is possible to select a data transmission speed using the control signal input pin(s).

As mentioned above, according to example embodiments of the present invention, the speed control of the interface between the host and the device is possible according to specific application purposes such as a test purpose, to thereby reduce power consumption.

In other example embodiments, the speed of the interface may be established by the device as well as the host.

Moreover, the initial interface speed may be determined as soon as power is supplied. Thus, it is possible to reduce unnecessary step(s) in determining the interface speed.

While example embodiments of the present invention and their advantages have been described in detail, it should be understood that various changes, substitutions and alterations might be made herein without departing from the scope of the invention.

What is claimed is:

1. A method of establishing data transmission speed between a host and a device connected to a serial Advanced Technology Attachment (ATA) interface, comprising:
initiating a first data transmission speed between the host and the device;
transmitting a data transmission speed change command; and
initiating a second data transmission speed different from the first data transmission speed in response to the data transmission speed change command.

2. The method of claim 1, wherein the data transmission speed change command is supplied from an external source.

3. The method of claim 2, wherein the data transmission speed change command is a control signal applied from the external source through a control signal input pin.

4. The method of claim 2, wherein the data transmission speed change command is provided from a register for storing speed mode change data provided from the external source.

5. The method of claim 1, wherein testing whether the second data transmission speed is supported by the host and the device, comprises:
generating a first matching signal having a specific pattern by the device and transmitting the first matching signal to the host;
generating a second matching signal by the host in response to the first matching signal and transmitting the second matching signal to the device;
generating a third matching signal by the device having the same pattern as that of the second matching signal in response to the second matching signal and transmitting the third matching signal to the host;
generating a fourth matching signal by the device and transmitting the fourth matching signal to the host at the second data transmission speed; and
generating a fifth matching signal by the host in response to the third matching signal and transmitting the fifth matching signal to the device at the second data transmission speed.

6. The method of claim 1, wherein testing whether the second data transmission speed is supported by the host and the device, comprises:
generating a first matching signal having a specific pattern by the host and transmitting the first matching signal to the device;
generating a second matching signal by the device in response to the first matching signal and transmitting the second matching signal to the host;
generating a third matching signal by the host having the same pattern as that of the second matching signal in response to the second matching signal and transmitting the third matching signal to the device;
generating a fourth matching signal by the device and transmitting the fourth matching signal to the host at the second data transmission speed; and
generating fifth matching signals by both the device and host, and exchanging the fifth signals.

7. A method of establishing data transmission speed between a host and a device connected to a serial Advanced Technology Attachment (ATA) interface, comprising:
initiating a first data transmission speed between the host and the device;
transmitting a data transmission speed change command;
initiating a second data transmission speed different from the first data transmission speed in response to the data transmission speed change command;
determining whether data transmission at the second data transmission speed is supported; and
maintaining the second data transmission speed if the second data transmission is supported.

8. The method of claim 7, wherein determining whether the second data transmission speed is supported, comprises:
generating a first matching signal having a specific pattern by the device and transmitting the first matching signal to the host;
generating a second matching signal by the host in response to the first matching signal and transmitting the second matching signal to the device;
generating a third matching signal by the device having the same pattern as that of the second matching signal in response to the second matching signal and transmitting the third matching signal to the host;
generating a fourth matching signal by the device and transmitting the fourth matching signal to the host at the second data transmission speed; and
generating a fifth matching signal by the host in response to the third matching signal and transmitting the fifth matching signal to the device at the second data transmission speed.

9. The method of claim 7, wherein determining whether the second data transmission speed is supported, comprises:
generating a first matching signal having a specific pattern by the host and transmitting the first matching signal to the device;
generating a second matching signal by the device in response to the first matching signal and transmitting the second matching signal to the host;
generating a third matching signal by the host having the same pattern as that of the second matching signal in response to the second matching signal and transmitting the third matching signal to the device;
generating a fourth matching signal by the device and transmitting the fourth matching signal to the host at the second data transmission speed; and
generating fifth matching signals by both the device and host, and exchanging the fifth signals.

10. A method of establishing data transmission speed between a host and a device connected to a serial Advanced Technology Attachment (ATA) interface, comprising:
initiating a first data transmission speed between the host and the device;
transmitting a data transmission speed change command;
initiating a second data transmission speed different from the first data transmission speed in response to the data transmission speed change command;
determining whether data transmission at the second data transmission speed is supported;
outputting an error result when the data transmission at the second data transmission speed is not supported; and
determining whether a different data transmission speed other than the second data transmission speed is supported.

11. The method of claim 10, wherein determining whether the second data transmission speed is supported, comprises:
generating a first matching signal having a specific pattern by the device and transmitting the first matching signal to the host;
generating a second matching signal by the host in response to the first matching signal and transmitting the second matching signal to the device;
generating a third matching signal by the device having the same pattern as that of the second matching signal in response to the second matching signal and transmitting the third matching signal to the host;
generating a fourth matching signal by the device and transmitting the fourth matching signal to the host at the second data transmission speed; and
generating a fifth matching signal by the host in response to the third matching signal and transmitting the fifth matching signal to the device at the second data transmission speed.

12. The method of claim 10, wherein determining whether the second data transmission speed is supported, comprises:
generating a first matching signal having a specific pattern by the host and transmitting the first matching signal to the device;
generating a second matching signal by the device in response to the first matching signal and transmitting the second matching signal to the host;
generating a third matching signal by the host having the same pattern as that of the second matching signal in response to the second matching signal and transmitting the third matching signal to the device;
generating a fourth matching signal by the device and transmitting the fourth matching signal to the host at the second data transmission speed; and
generating fifth matching signals by both the device and host, and exchanging the fifth signals.

13. The method of claim 10, wherein determining the different data transmission speed, comprises:
selecting a new data transmission speed; and
determining whether the new data transmission speed is supported.

14. The method of claim 13, wherein determining whether the new data transmission speed is supported, comprises:
generating a first matching signal having a specific pattern by the device and transmitting the first matching signal to the host;
generating a second matching signal by the host in response to the first matching signal and transmitting the second matching signal to the device;
generating a third matching signal by the device having the same pattern as that of the second matching signal in response to the second matching signal and transmitting the third matching signal to the host;
generating a fourth matching signal by the device and transmitting the fourth matching signal to the host at the second data transmission speed; and
generating a fifth matching signal by the host in response to the third matching signal and transmitting the fifth matching signal to the device at the second data transmission speed.

15. The method of claim 13, wherein determining whether the new data transmission speed is supported, comprises:
generating a first matching signal having a specific pattern by the host and transmitting the first matching signal to the device;
generating a second matching signal by the device in response to the first matching signal and transmitting the second matching signal to the host;
generating a third matching signal by the host having the same pattern as that of the second matching signal in response to the second matching signal and transmitting the third matching signal to the device;
generating a fourth matching signal by the device and transmitting the fourth matching signal to the host at the second data transmission speed; and
generating fifth matching signals by both the device and host, and exchanging the fifth signals.

16. The method of claim 13, wherein the new data transmission speed is selected using the equation: 1.5×2ⁿ⁻¹ Gbps, wherein n is a natural number.

17. The method of claim 13, wherein if the new data transmission speed is not supported, selecting the next available data transmission speed, determining whether the next available data transmission speed is supported, and if the next available data transmission speed is supported maintaining the next available data transmission.

18. The method of claim 17, wherein determining whether the next available data transmission speed is supported, comprises:
generating a first matching signal having a specific pattern by the device and transmitting the first matching signal to the host;
generating a second matching signal by the host in response to the first matching signal and transmitting the second matching signal to the device;
generating a third matching signal by the device having the same pattern as that of the second matching signal in response to the second matching signal and transmitting the third matching signal to the host;
generating a fourth matching signal by the device and transmitting the fourth matching signal to the host at the second data transmission speed; and
generating a fifth matching signal by the host in response to the third matching signal and transmitting the fifth matching signal to the device at the second data transmission speed.

19. The method of claim 17, wherein determining whether the next available data transmission speed is supported, comprises:
generating a first matching signal having a specific pattern by the host and transmitting the first matching signal to the device;
generating a second matching signal by the device in response to the first matching signal and transmitting the second matching signal to the host;
generating a third matching signal by the host having the same pattern as that of the second matching signal in response to the second matching signal and transmitting the third matching signal to the device;
generating a fourth matching signal by the device and transmitting the fourth matching signal to the host at the second data transmission speed; and
generating fifth matching signals by both the device and host, and exchanging the fifth signals.

20. The method of claim 17, wherein if the new data transmission speed is not supported, determining whether the new data transmission speed is the slowest speed available, and if the new data transmission speed is the slowest speed available, reporting an error result.

21. An apparatus for establishing data transmission speed between a host and a device connected to a serial Advanced Technology Attachment (ATA) interface, comprising:
a clock generator configured to generate a corresponding clock signal in response to the data transmission speed supported by the host and the device;
a transmitter configured to transmit a first data in response to the corresponding clock signal;
a receiver configured to receive a second data in response to the corresponding clock signal; and
an interface controller configured to control the clock generator by means of selecting one among the plurality of available data transmission speed, and configured to establish data transmission speed between the host and the device by means of controlling the clock generator in response to a data transmission speed change command.

22. The apparatus of claim 21, further comprising an input pin for receiving the transmission speed change command from an external source.

23. The apparatus of claim 21, further comprising a register for storing data transmission speed modes available by the transmission speed change command.
